(19) United States
(12) Patent Application Publication
(10) Pub. No.: US 2023/0005376 A1
(43) Pub. Date: Jan. 5, 2023

(54) METHOD FOR PROVIDING MULTIMODAL TRANSPORT SERVICE BASED ON AIR VEHICLE AND APPARATUS FOR THE SAME

(71) Applicants: HYUNDAI MOTOR COMPANY, SEOUL (KR); KIA CORPORATION, SEOUL (KR)

(72) Inventors: Jae Jun Ha, Hwaseong-si (KR); Young Jun Moon, Sejong-si (KR)

(21) Appl. No.: 17/728,123

(22) Filed: Apr. 25, 2022

(30) Foreign Application Priority Data
Jul. 1, 2021 (KR) 10-2021-0086649

(51) Int. Cl. G08G 5/00

(52) U.S. Cl. CPC G08G 5/0017

(57) ABSTRACT

A method for providing a multimodal transport service based on a personal air vehicle may include checking, for at least one traffic object, route information including waypoint information and destination information, checking destination information of at least one passenger, setting service use information based on the route information for the at least one traffic object and the destination information of the at least one passenger, checking the service use information of the traffic object that approaches a take-off and landing facility, setting a transport zone as an entry zone of the traffic object, in response to a demand for transport processing of the traffic object, and processing the at least one passenger's getting into the traffic object.

### CROSS REFERENCE TO RELATED APPLICATIONS

The present application claims priority to Korean patent application 10-2021-0086649, filed Jul. 1, 2021, the entire contents of which are incorporated herein for all purposes by this reference.

### BACKGROUND

### Field

The present disclosure relates to a method and apparatus for multimodal transport using an air vehicle, and particularly to a method and apparatus for providing multimodal transport of a user in a facility where an air vehicle takes off and lands.

### Description of the Related Art

Next-generation air mobility devices such as an urban air mobility (UAM) and a personal air vehicle (PAV) have been devised to overcome the limitations of the existing means of transportation running on the ground and to travel in the three-dimensional space. Unlike the traditional means of aviation transport including the existing aircrafts and helicopters, those next-generation air mobility devices are being developed to take off and land in various types of space without separate large facility dedicated to take-off and landing.

### SUMMARY

Although next-generation air mobility devices do not require a large separate facility dedicated to take-off and landing, if many air vehicles are distributed, the air vehicles are supposed to operate in a prearranged altitude zone under air control. Although an air vehicle does not require a large separate facility dedicated to take-off and landing, a basic facility, which enables an air vehicle to take off and land, may be needed to control smoothly the movement or operation of the air vehicle.

In addition, due to the characteristics of air vehicles, a take-off and landing facility is likely to be constructed in a peripheral region. Considering this condition, a user needs to go to a take-off and landing facility by means of a moving object and the like. Accordingly, a take-off and landing facility may be built up not only for the take-off and landing of air vehicles but also to allow multimodal access of other traffic objects.

The present disclosure may provide a structure of a multimodal transport system that is capable of effectively realizing a user's transport between multimodal traffic objects in an environment of a take-off and landing facility, which is required for the operation of an air vehicle.

Also, the present disclosure may provide a method and apparatus for controlling efficiently a traffic service for a user by utilizing a structure of a multimodal transport system that is prepared in a take-off and landing facility.

According to an embodiment of the present disclosure, a method for providing a multimodal transport service based on an air vehicle may be provided. The method may include checking, for at least one traffic object, route information including waypoint information and destination information, checking destination information of at least one passenger, setting service use information based on the route information for the at least one traffic object and the destination information of the at least one passenger, checking the service use information of the traffic object that approaches a take-off and landing facility, setting a transport zone as an entry zone of the traffic object, in response to a demand for transport processing of the traffic object, and processing the at least one passenger's getting into the traffic object.

The setting of the service use information may include identifying the at least one passenger corresponding to waypoint information or destination information for the at least one traffic object.

The setting of the service use information may include providing a target passenger list, which includes the at least one passenger, to the at least one traffic object; and selecting the at least one passenger included in the target passenger list.

The service use information may include at least one among traffic object information, information on a passenger's getting-in location, a getting-in time, information on a passenger's getting-off location, and a getting-off time.

The traffic object may include at least one of an air vehicle and a moving object.

Checking a change in the destination or waypoint of the at least one traffic object may be included.

Resetting a route by reflecting the changed destination or waypoint of the at least one traffic object may further be included.

Checking whether or not a destination or a waypoint, which is included in the reset route, matches the destination of the at least one passenger may further be included.

As the destination or waypoint, which is included in the reset route, matches the destination of the at least one passenger, an operation of the at least one traffic object may be controlled according to the reset route.

As the destination or waypoint, which is included in the reset route, does not match the destination of the at least one passenger, processing a waypoint negotiation between the destination of the at least one passenger and the at least one traffic object may be included.

The processing of the waypoint negotiation between the destination of the at least one passenger and the at least one traffic object may include providing a waypoint list, which is included in the reset route, to a user terminal of the passenger; and resetting the destination of the at least one passenger by selecting at least one waypoint included in the list.

The processing of the waypoint negotiation between the destination of the at least one passenger and the at least one traffic object may include checking at least one neighboring waypoint, and resetting the destination of the at least one passenger by using the at least one neighboring waypoint.

The processing of the waypoint negotiation between the destination of the at least one passenger and the at least one traffic object may include determining a priority for the at least one traffic object or the at least one passenger, and determining the waypoint of the at least one traffic object by reflecting the priority.

Managing a mileage for the at least one traffic object and a mileage for the at least one passenger may further be included.

The determining of the priority may include checking the mileage for the at least one traffic object and the mileage for the at least passenger, and determining a higher priority for either of the traffic object and the passenger, of which the mileage is relatively higher.

The method for providing a multimodal transport service may include checking a change of destination for the at least one passenger.

The method for providing a multimodal transport service may further include checking whether or not the changed destination of the at least one passenger matches a waypoint or destination for the at least one traffic object.

The method for providing a multimodal transport service may further include resetting the route information, when the changed destination of the at least one passenger matches a waypoint or destination for the at least one traffic object.

The method for providing a multimodal transport service may include processing a waypoint negotiation between the changed destination of the at least one passenger and the at least one traffic object, when the changed destination of the at least one passenger does not match the waypoint or destination for the at least one traffic object.

The method for providing a multimodal transport service may include setting a transport zone as an entry zone of the traffic object in response to a demand for transport processing of the traffic object.

The take-off and landing facility may include at least one of an air vehicle transport zone, where an air vehicle may stop, and a moving object transport zone, where a moving object may stop.

In the take-off and landing facility, the air vehicle transport zone and the moving object transport zone may be prepared on a same plane and be distinguished by different areas.

In the take-off and landing facility, the air vehicle transport zone and the moving object transport zone may be prepared on different planes.

The take-off and landing facility may include at least one of a general air vehicle stop zone, where the air vehicle may stop, and a general moving object stop zone, where the moving object may stop.

The general air vehicle stop zone and the general moving object stop zone may be prepared in an area different from an area for the air vehicle transport zone and the moving object transport zone.

The general air vehicle stop zone and the air vehicle transport zone may be prepared in a same first plane, and the general moving object stop zone and the moving object transport zone may be prepared on a same plane, which is a second plane different from the first plane.

The method for providing a multimodal transport service may include selecting freight to be transferred through the at least one traffic object, and loading or unloading the selected freight to or from the at least one traffic object.

According to another embodiment of the present disclosure, a multimodal transport system for processing a multimodal transport service may be provided. The multimodal transport system may include at least one air vehicle, at least one moving object, a multimodal transport facility that includes an air vehicle transport zone, in which the at least one air vehicle may stop, and a moving object transport zone, in which the at least one moving object may stop, and a server apparatus capable of managing the multimodal transport service using the multimodal transport facility. Herein, the server apparatus may be configured to set service use information based on route information for the air vehicle or the moving object and destination information of at least one passenger and to process the at least one passenger's getting into the air vehicle or the moving object based on the service use information.

The service use information may include the at least one passenger corresponding to waypoint information or destination information for the at least one traffic object.

According to another embodiment of the present disclosure, in a multimodal transport system, a transport management server apparatus for processing a multimodal transport service may be provided. The transport management server apparatus may include: a communication unit capable of communicating with at least one air vehicle and at least one moving object; at least one storage medium; and at least one processor. The at least one processor may be configured to set service use information based on route information for the air vehicle or the moving object and destination information of at least one passenger and to processing the at least one passenger's getting into the air vehicle or the moving object.

The at least one processor may check the at least one passenger corresponding to waypoint information or destination information for the air vehicle or the moving object.

The at least one processor may be configured to provide a target passenger list, which includes the at least one passenger, to the air vehicle or the moving object and to select the at least one passenger included in the target passenger list.

The service use information may include at least one among traffic object information, information on a passenger's getting-in location, a getting-in time, information on a passenger's getting-off location, and a getting-off time.

The at least one processor may be configured to identify a change in a destination or waypoint of the air vehicle or the moving object and to reset a route by reflecting a changed destination or waypoint of the at least one traffic object.

The at least one processor may be configured to check whether or not a destination or a waypoint, which is included in the reset route, matches the destination of the at least one passenger.

The at least one processor may be configured to control an operation of the air vehicle or the moving object according to the reset route, when the destination or waypoint, which is included in the reset route, matches the destination of the at least one passenger.

The at least one processor may be configured to process a waypoint negotiation between the destination of the at least one passenger and the air vehicle or the moving object, when the destination or waypoint, which is included in the reset route, does not match the destination of the at least one passenger.

The at least one processor may be configured to process the waypoint negotiation by providing a list for a waypoint included in the reset route to a user terminal of the passenger, by selecting at least one waypoint included in the list and by resetting the destination of the at least one passenger.

The at least one processor may be configured to reset the destination of the at least one passenger by checking at least one neighboring waypoint and by using the at least one neighboring waypoint.

The at least one processor may be configured to process a waypoint negotiation by determining a priority for the at least one passenger and by determining a waypoint of the air vehicle or the moving object by reflecting the priority.

The at least one processor may be configured to manage a mileage for the air vehicle or the moving object and a mileage for the at least one passenger.

The at least one processor may be configured to check a mileage for the air vehicle or the moving object and a mileage for the at least one passenger and to determine a higher priority for either of the air vehicle and the moving object, which has a relatively higher mileage.

The at least one processor may be configured to check a change of destination for the at least one passenger.

The at least one processor may be configured to check whether or not the changed destination of the at least one passenger matches a waypoint or a destination for the air vehicle or the moving object.

The at least one processor may be configured to reset the route information, when the changed destination of the at least one passenger matches the waypoint or the destination for the air vehicle or the moving object.

The at least one processor may be configured to process a waypoint negotiation between the changed destination of the at least one passenger and the air vehicle or the moving object, when the changed destination of the at least one passenger does not match the waypoint or the destination for the air vehicle or the moving object.

According to yet another embodiment of the present disclosure, in a multimodal transport system, at least one traffic object capable of processing a multimodal transport service may be provided. The traffic object may include a communication unit, at least one storage medium, and at least one processor. The at least one processor may be configured to: check route information of the at least one traffic object, provide the route information to the transport management server, receive a target passenger list including the at least one passenger from the transport management server, select and provide the at least one passenger included in the target passenger list to the transport management server, check the service use information, and provide the service use information.

The at least one processor may be configured to provide a target passenger list, which includes the at least one passenger, to the at least one traffic object and to select the at least one passenger included in the target passenger list.

The at least one processor may be configured to check a change of a destination or waypoint of the at least one traffic object.

The at least one processor may be configured to check a route that is reset by reflecting the changed destination or waypoint of the at least one traffic object.

The at least one processor may be configured to reset a route by reflecting the changed destination or waypoint of the at least one traffic object and to provide the reset route to the transport management server.

The at least one processor may be configured to provide the changed destination or waypoint of the at least one traffic object to the transport management server, to receive a route that is reset by the transport management server, and to provide the received and reset route.

According to yet another embodiment of the present disclosure, a facility apparatus may be provided which supports take-off and landing of at least one moving object and at least one air vehicle. The facility apparatus may include a moving object stop where the at least one moving object stops, an air vehicle stop where the at least one air vehicle stops, an air vehicle transport zone where the at least one air vehicle may stop, a moving object transport zone where the at least moving object may stop, a take-off and landing pad where the at least air vehicle takes off and lands, and a server apparatus capable of controlling an operation of the at least one moving object or the at least one air vehicle.

The air vehicle transport zone and the moving object transport zone may be prepared on a same plane and be distinguished by different areas.

The air vehicle transport zone and the moving object transport zone may be prepared on different planes.

At least one of a general air vehicle stop zone where the air vehicle may stop and a general moving object stop zone where the moving object may stop may be included.

The general air vehicle stop zone and the general moving object stop zone may be prepared in an area different from an area for the air vehicle transport zone and the moving object transport zone.

The general air vehicle stop zone and the air vehicle transport zone may be prepared in a same first plane, and the general moving object stop zone and the moving object transport zone may be prepared on a same plane, which is a second plane different from the first plane.

The present disclosure may provide a multimodal transport system that is capable of effectively realizing a multimodal traffic service by using a multimodal traffic object in an environment of a stops take-off and landing facility, which is required for the operation of an air vehicle.

Also, the present disclosure may provide a method and apparatus for controlling efficiently a transport service of a user by utilizing a structure of a multimodal transport system that is prepared in a take-off and landing facility.

### BRIEF DESCRIPTION OF THE FIGURES

FIGS. 1A, 1B, and 1C are views illustrating air vehicle operation zones used in a multimodal transport system according to an embodiment of the present disclosure.

FIG. 2A is a view illustrating the structure of a take-off and landing facility and an air vehicle operation zone, which are prepared in a multimodal transport system, according to an embodiment of the present disclosure.

FIG. 2B is another view illustrating the structure of a take-off and landing facility and an air vehicle operation zone, which are prepared in a multimodal transport system, according to an embodiment of the present disclosure.

FIG. 3A is a conceptual view showing schematically a configuration of a multimodal transport system according to an embodiment of the present disclosure.

FIG. 3B is a view illustrating a structure of a multimodal transport system according to an embodiment of the present disclosure.

FIGS. 4A, 4B, 4C, and 4D illustrate a structure of a take-off and landing facility in a multimodal transport system according to an embodiment of the present disclosure.

FIG. 5A is a view illustrating an operation of setting multimodal traffic service use in a multimodal transport system according to an embodiment of the present disclosure.

FIG. 5B is a view illustrating an operation of processing a multimodal traffic service in a multimodal transport system according to an embodiment of the present disclosure.

FIG. 6A is a view illustrating an operation of processing a change of destination of an air vehicle in a multimodal transport system according to an embodiment of the present disclosure.

FIG. 6B is a view illustrating an operation of negotiation for the changed destination of FIG. 6A.

FIG. 7A is another view illustrating an operation of processing a change of destination of an air vehicle in a multimodal transport system according to an embodiment of the present disclosure.

FIG. 7B is a view illustrating an operation of negotiation for the changed destination of FIG. 7A.

FIG. 8 is a block diagram illustrating a configuration of a local transport management server in an air vehicle control system according to an embodiment of the present disclosure.

FIG. 9 is a block diagram illustrating a configuration of a central transport management server in an air vehicle control system according to an embodiment of the present disclosure.

FIG. 10 is a view illustrating an apparatus configuration according to an embodiment of the present disclosure.

### DETAILED DESCRIPTION

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc. unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various exemplary embodiments are not necessarily essential components, and some may be optional components. Accordingly, exemplary embodiments consisting of a subset of the components described in one embodiment are also included within the scope of the present disclosure. Also, exemplary embodiments that include other components in addition to the components described in the various embodiments are also included in the scope of the present disclosure.

Advantages and features of the present disclosure, and methods for achieving them will be apparent with reference to the exemplary embodiments described below in detail with reference to the accompanying drawings. However, the present disclosure is not limited to the exemplary embodiments set forth herein but may be embodied in many different forms. The present exemplary embodiments are provided to make disclosed contents of the present disclosure thorough and complete and to completely convey the scope of the disclosure to those with ordinary skill in the art.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

An aerial vehicle control system according to an embodiment of the present disclosure may include a system for controlling next-generation aerial mobility devices such as an urban air mobility (UAM) and a personal air vehicle (PAV). When a configuration or operation of an aerial vehicle control system is described according to an embodiment of the present disclosure, a personal aerial vehicle is used, but the present disclosure does not limit next-generation aerial mobility devices to personal aerial vehicles, and various next-generation mobility devices may be used.

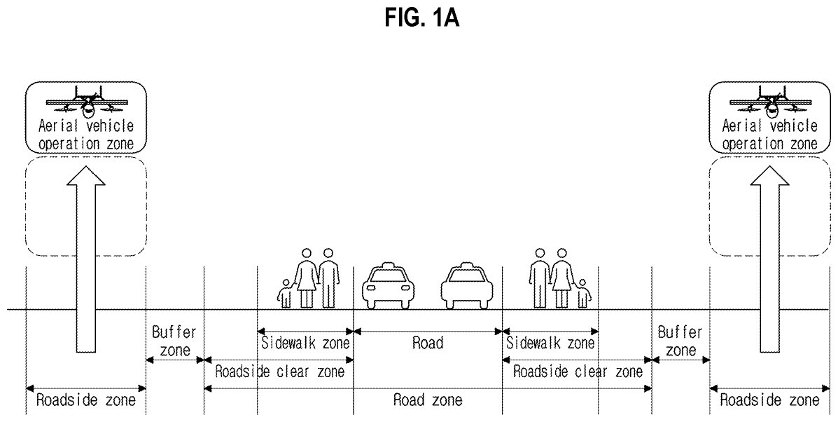

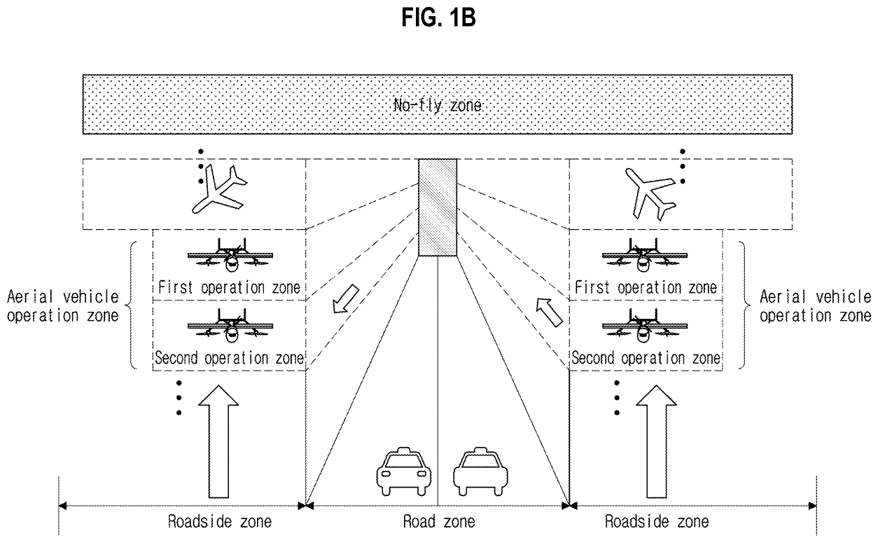

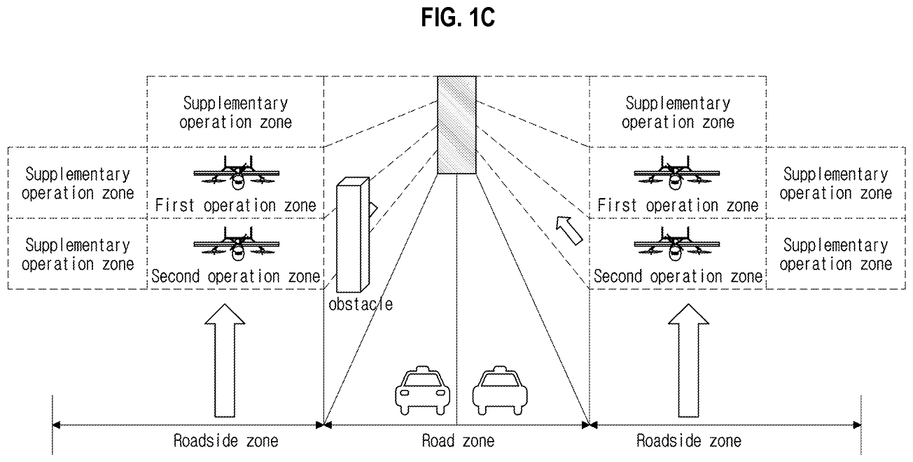

FIGS. 1A to 1C are views illustrating operation zones for an aerial vehicle used in an aerial vehicle control system according to an embodiment of the present disclosure.

In an embodiment of the present disclosure, an aerial vehicle control system may control movement of an aerial vehicle, particularly to enable the aerial vehicle to move in an aerial vehicle operation zone.

First, referring to FIG. 1A, an aerial vehicle operation zone may be set based on a road zone in which a moving object is operated. Herein, the road zone may be a zone on the ground in which a road is set. Herein, the road may include a driveway, in which a moving object is moved, and a sidewalk zone in which people move. As another example, a road zone may include a road zone and a roadside clear zone, which are set according to a road act.

As an example, an aerial vehicle operation zone may be set as a zone at a predetermined height or higher above a road zone. Furthermore, in case a personal aerial vehicle has an abnormality and lands or crashes while operating in an aerial vehicle operation zone set above a road zone, a moving object (or a person) moving in the road zone may be affected. Accordingly, it is desirable that an aerial vehicle operation zone is set vertically above a neighboring zone of a road zone (hereinafter, referred to as “roadside zone”), instead of vertically above the road zone. For example, it is desirable that a preset distance range from a road zone is set as a roadside zone and an aerial vehicle operation zone is set above the roadside zone. Furthermore, a predetermined buffer zone may be set between the road zone and the roadside zone.

Referring to FIG. 1B, an aerial vehicle operation zone may include a multiplicity of operation zones that are distinguished in vertical direction. For example, an aerial vehicle operation zone may include a first operation zone and a second operation zone, and the first operation zone may be managed as a higher course than the second operation zone. In addition, a first operation zone may be set and managed as a relatively higher zone than a second operation zone. Accordingly, an aerial vehicle control system may control an aerial vehicle moving at relatively high speed to move in the first operation zone and control an aerial vehicle moving at relatively low speed to move in the second operation zone. As another example, an aerial vehicle control system may manage a second operation zone as a slow land and a first operation zone as a fast lane.

As yet another example, a type of an aerial vehicle may be set according to size or purpose of use, and a type of an aerial vehicle capable of operating in a multiplicity of operation zones may be set and managed. As an example, according to purpose of use, aerial vehicles may be classified into passenger aerial vehicles and cargo aerial vehicles. Accordingly, an aerial vehicle control system may control a passenger aerial vehicle to move in the first operation zone and control a cargo aerial vehicle to move in the second operation zone. As another example, according to size, aerial vehicles may be classified into small aerial vehicles, mid-sized aerial vehicles and large aerial vehicles. Correspondingly, an aerial vehicle control system may control an aerial vehicle with relatively large size to operate in a higher course. As an example, an aerial vehicle control system may control a large aerial vehicle to move in the first operation zone and control a small aerial vehicle or a mid-sized aerial vehicle to move in the second operation zone. As yet another example, an aerial vehicle operation zone may include a first operation zone, a second operation zone and a third operation zone, and an aerial vehicle control system may control a large aerial vehicle to move in the first operation zone, a mid-sized aerial vehicle to move in the second operation zone and a small aerial vehicle to move in the third operation zone.

In an embodiment of the present disclosure, a first operation zone, a second operation zone and a third operation zone are illustrated as multiple operation zones, but the present disclosure is not limited thereto, and the number of operation zones may vary.

Referring to FIG. 1C, in an embodiment of the present disclosure, an aerial vehicle operation zone may include a supplementary operation zone capable of expanding an operation zone either vertically or horizontally. For example, there may be an obstacle at a certain point or in a section of an aerial vehicle operation zone, a supplementary operation zone may be set to drive by evading the obstacle. As an example, a supplementary operation zone may be configured by expanding an operation zone in vertical direction. As another example, one of 8 directions from an operation path of an aerial vehicle may be set as a supplementary operation zone.

Furthermore, a supplementary operation zone may be configured adaptively according to a type of an obstacle. For example, in case there is a fixed obstacle, an aerial vehicle control system may set a supplementary operation zone in a corresponding section so that an aerial vehicle operation zone may be managed by being temporarily expanded. As another example, in case a movable obstacle is identified, an aerial vehicle control system may identify a movement direction and speed of the movable obstacle and set a supplementary operation zone by selecting one of 8 directions from an operation course of an aerial vehicle as an optimal evasion zone.

As an example, an aerial vehicle operation zone may be set based on a predetermined altitude. As another example, an aerial vehicle operation zone may change its altitude adaptively according to weather information. For example, weather information may include information for identifying weather conditions like snowfall, rainfall, fog and the like, and an altitude range of an aerial vehicle operation zone may be set based on such weather information. An altitude range of an aerial vehicle operation zone may be set in predetermined distance units (e.g., 300 m, 500 m, and 1 km).

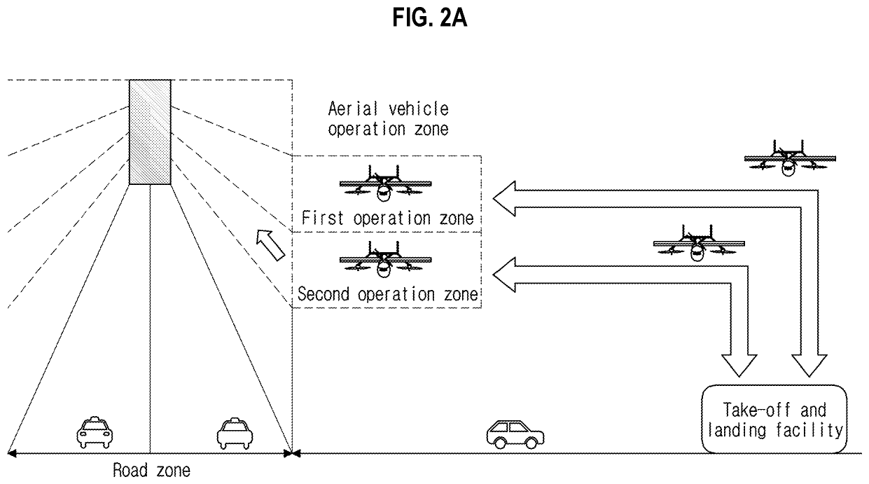

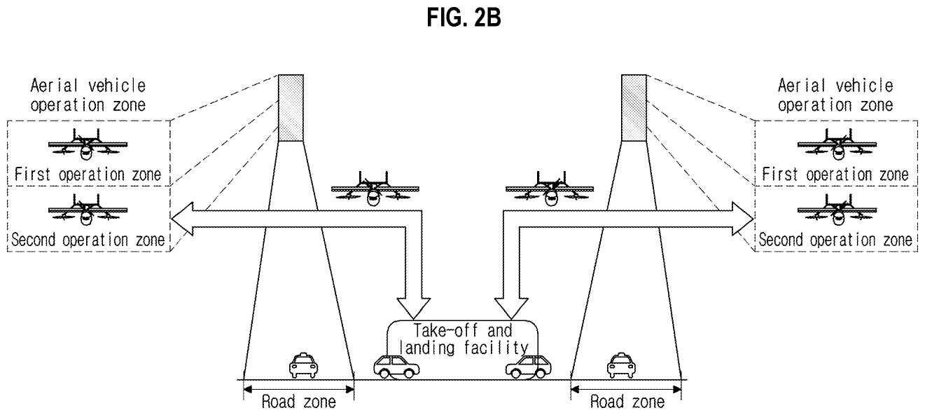

Meanwhile, referring to FIG. 2A, an aerial vehicle may enter an aerial vehicle operation zone restrictedly through a take-off and landing facility. Herein, the take-off and landing facility may include a space, in which an aerial vehicle may take off or land, and a controller capable of controlling entry into and exit from an aerial vehicle operation zone. As an example, the take-off and landing facility may include an expressway tollgate facility, a service facility and the like. Furthermore, it is desirable that the take-off and landing facility is installed at one side or both sides of a road zone.

As another example, referring to FIG. 2B, a road zone may have a northbound lane and a southbound lane separate from each other, and an expressway tollgate facility, a service facility and the like may be installed in the central areas of the northbound lane and the southbound lane respectively. Thus, a take-off and landing facility may be located in the central area of a road zone.

Furthermore, a take-off and landing facility may be connected with a control server that performs control of take-off and landing of an aerial vehicle, control of entry into and exit from an aerial vehicle operation zone, and information exchange with an aerial vehicle. A control server may include a local control server and a central control server. A local control server may include a server that is provided within a take-off and landing facility or adjacent to the take-off and landing facility. In addition, a central control server may include a server that is connected with at least one local control server and performs overall control of an aerial vehicle control system.

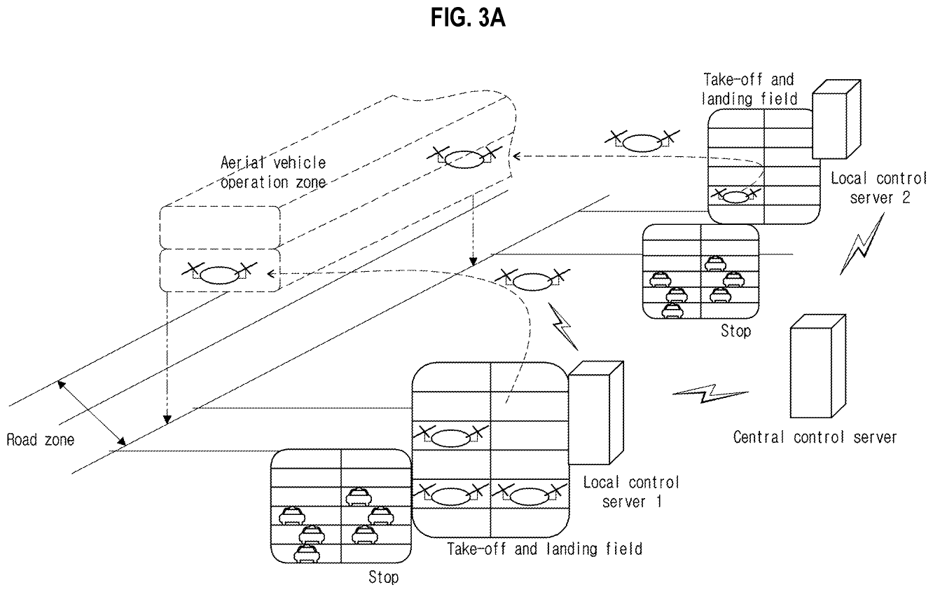

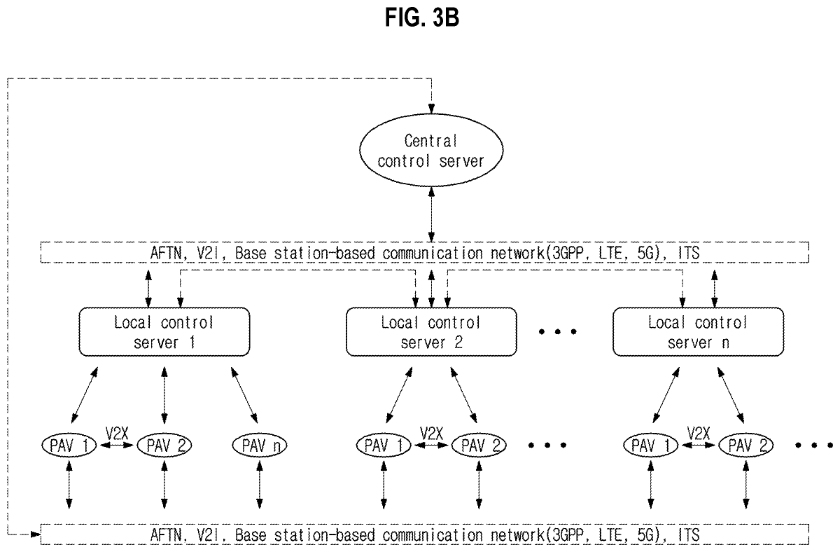

FIG. 3A is a conceptual view showing schematically a configuration of an aerial vehicle control system according to an embodiment of the present disclosure, and FIG. 3B is a view illustrating a structure of an aerial vehicle control system according to an embodiment of the present disclosure.

Referring to FIG. 3A, a take-off and landing facility and an aerial vehicle operation zone may be set, and an aerial vehicle control system may control the movement or operation of a personal aerial vehicle in the take-off and landing facility and the aerial vehicle operation zone.

A take-off and landing facility may include a stop, in which a personal aerial vehicle or a moving object may stop, and a take-off and landing field in which a personal aerial vehicle may take off and land. Herein, the stop and the take-off and landing field may be set as different areas on a single plane. As another example, a take-off and landing facility may include a building constructed with a multiplicity of floors, and a stop and a take-off and landing field may be set on different floors. As yet another example, a stop may be configured to separate areas in which a personal aerial vehicle or a moving object may stop. For example, a stop may include a first stop, where a personal aerial vehicle stands, and a second stop where a moving object stops. A first stop and a second stop may set as different areas on a single plane or as different floors. As yet another example, a first stop and a take-off and landing field may be set as different areas on a single plane, and a second stop may be set as a different floor from the first stop and the take-off and landing field.

For example, a personal aerial vehicle may be available in a road zone, a stop, a take-off and landing field and an aerial vehicle operation zone and may include a moving object with a shape capable of vertical take-off and landing (e.g., vertical take-off and landing (VTOL) and electric vertical take-off and landing (e-VTOL)). Accordingly, a personal aerial vehicle may move from a road zone to a stop, a take-off and landing field and the like and move from the take-off and landing field to an aerial vehicle operation zone under the control of a control server (local control server or central control server). In addition, under the control of a control server (local control server or central control server), a personal aerial vehicle may move from an aerial vehicle operation zone to a take-off and landing field.

Furthermore, in an embodiment of the present disclosure, a section, in which a personal aerial vehicle is moved from a take-off and landing field to an aerial vehicle operation zone, is called an entry section, and a section, in which the personal aerial vehicle is moved from the aerial vehicle operation zone to the take-off and landing field, is called an exit section.

Meanwhile, a central control server may be connected with a local control server via a communication network and receive information on a personal aerial vehicle from the local control server. In addition, the central control server may provide the local control server with information necessary to control a personal aerial vehicle or to control an entry section or an exit section. In addition, the central control server may provide operation information necessary for a personal aerial vehicle to operate in an aerial vehicle operation zone. Meanwhile, although a personal aerial vehicle may freely move in a take-off and landing field, an entry section, an exit section and an aerial vehicle operation zone, as personal aerial vehicles move at relatively high speed, an accident is very likely to happen in the take-off and landing field, the entry section and the exit section. Accordingly, it is necessary to set control right for movement or operation by distinguishing a local control server, a central control server, a personal aerial vehicle and the like according to a location or situation of the personal aerial vehicle.

Referring to FIG. 3B, an aerial vehicle control system according to an embodiment of the present disclosure may include a local control server, a central control server, and a personal aerial vehicle, and the local control server, the central control server and the personal aerial vehicle may exchange information necessary for control via communication. Also, a personal aerial vehicle may control movement or operation based on information received from a local control server and a central control server.

A personal aerial vehicle and a local control server may be connected with each other based on a vehicle to everything (V2X) communication scheme, and the personal aerial vehicle and a central control server may be connected with each other based on a vehicle to everything (V2X) communication scheme. As an example, it is desirable that a personal aerial vehicle and a local control server are connected to each other through a vehicle to infrastructure (V2I) scheme and the personal aerial vehicle and a central control server are connected to each other through a V2I scheme. A personal aerial vehicle and a local control server may be connected with each other via aeronautical telecommunication network (AFTN), and the personal aerial vehicle and a central control server may be connected with each other via AFTN. As yet another example, a personal aerial vehicle and a local control server may be connected with each other via a base station-based communication network, and the personal aerial vehicle and a central control server may be connected with each other via a base station-based communication network. As an example, a base station-based communication network may include a cellular communication network, a communication network based on 3rd generation partnership project (3GPP), a communication network based on long term evolution (LTE) and a communication network based on fifth generation (5G) technology standard. Although, in an embodiment of the present disclosure, a communication network based on 3rd generation partnership project (3GPP), a communication network based on long term evolution (LTE) and a communication network based on fifth generation (5G) technology standard are described as examples of base station-based communications, but the present disclosure is not limited thereto, and various types of cellular communication networks may be used.

Furthermore, an aerial vehicle control system according to an embodiment of the present disclosure may configure different communication networks connecting a local control server or a central control server according to a location of a personal aerial vehicle. As an example, in case a personal aerial vehicle exists within a take-off and landing facility or exists in an entry section or an exit section, the personal aerial vehicle may be connected with a local control server based on an X2V scheme. In addition, in case the personal aerial vehicle exists in an aerial vehicle operation zone, the personal aerial vehicle may be connected with the central control server (or local control server) via AFTN or cellular communication network.

In addition, a personal aerial vehicle may be connected with another personal aerial vehicle through a V2X scheme. Thus, a personal aerial vehicle may be connected with another neighboring personal aerial vehicle through a V2X scheme, and a distance between neighboring personal aerial vehicles may be measured so that a collision between personal aerial vehicles may be prevented.

Basically, a central control server may set an operation condition in an aerial vehicle control system such as an entry section, an exit section, an aerial vehicle operation zone and the like and set and provide a control parameter matching the operation condition to a local control server or a personal aerial vehicle. Herein, the operation condition may include a speed, an interval, a set altitude of an aerial vehicle operation zone and the like.

Furthermore, a central control server may check and store a weather condition necessary to set an operation condition. To this end, the central control server may be connected with a device (or server) capable of providing weather information via a communication network and receive and store weather information periodically. As another example, the central control server may receive and store weather information from a device (or server) capable of providing weather information whenever a preset condition (e.g., lighting, gale, storm, heavy rainfall) is satisfied.

Also, a central control server may manage operation information of a personal aerial vehicle operated within an aerial vehicle control system and identify and manage a degree of congestion of each section of an aerial vehicle operation zone based on the operation information.

Also, a central control server may identify and manage event information (e.g., accident, obstacle, emergency situation) occurring within an aerial vehicle operation zone.

Also, a central control server may perform network linkage between local control servers, management of situations in a take-off and landing facility connected to a local control server, and the like.

Meanwhile, a local control server may manage control right of a personal aerial vehicle in an entry section, an exit section and an aerial vehicle operation zone. As an example, a local control server may set control right of a personal aerial vehicle to a local control server or to a personal aerial vehicle. To this end, a local control server may receive information required to set control right of a personal aerial vehicle from the personal aerial vehicle and set and manage the control right for the personal aerial vehicle based on the received information.

Also, a local control server may identify and manage a condition of a stop, a condition of a take-off and landing field and the like. For example, the condition of a stop may include an occupancy state of a spot included in the stop, an identifier of a moving object or a personal aerial vehicle present at the occupied spot and the like. Likewise, the condition of a take-off and landing field may include an occupancy state of a spot included in the take-off and landing field, an identifier of a personal aerial vehicle present at the occupied spot and the like. Furthermore, a local control server may identify and manage a degree of congestion in a take-off and landing facility based on a condition of a stop, a condition of a take-off and landing field and the like.

Furthermore, a local control server may check and store the above-described weather condition. As an example, a local control server may receive and store weather information from a central control server. As another example, a local control server may be connected with a device (or server) capable of providing weather information via a communication network and receive and store weather information periodically. Also, a local control server may store and manage operation conditions like an entry section, an exit section and an aerial vehicle operation zone. An operation condition may be received from a central control server and be managed.

Also, a local control server may identify and manage event information (e.g., accident, obstacle, emergency situation) occurring within an aerial vehicle operation zone. Event information may be received from a central control server or be generated based on a degree of congestion of a take-off and landing facility, weather information and the like.

Meanwhile, like a conventional personal aerial vehicle, a personal aerial vehicle may be controlled to move in a predetermined airspace, and the movement may be controlled through a user's operation control or autonomous driving control. Particularly, the movement or operation of a personal aerial vehicle may be controlled in a take-off and landing field, an entry section, an exit section, and an aerial vehicle operation zone, and the movement or operation may be controlled based on information received from a local control server or a central control server. Furthermore, control right of a personal aerial vehicle may be determined according to a zone that is set in an aerial vehicle control system, and movement or operation may be controlled in response to the determined control right.

A multimodal transport system based on an air vehicle (hereinafter, referred to as ‘multimodal transport system’) according to an embodiment of the present disclosure may be a system that processes transport of various traffic entities by using a take-off and landing facility, where an air vehicle takes off and land, as a transport hub. Basically, a multimodal transport system may include an environment in which the departure point and destination of a user may be identified and the user may move from the departure point to the destination. In addition, a multimodal transport system may include an environment in which a user may be moved from a departure point to a destination especially by means of an air vehicle or a moving object. As an example, a multimodal transport system may be configured to perform and manage transport between air vehicles, transport between an air vehicle and a moving object, and transport between moving objects.

A multimodal transport system may include a transport management server that is capable of processing management of a user's departure point or destination, management of a departure or destination of an air vehicle (or moving object), and matching the user with the air vehicle (or moving object). Furthermore, a transport management server may include a central transport management server, which performs overall management of transport of a user, and a local transport management server corresponding to each take-off and landing facility.

Hereinafter, a detailed structure of a take-off and landing facility, an operation of a central transport management server, an operation of a local transport management server and the like will be described in detail.

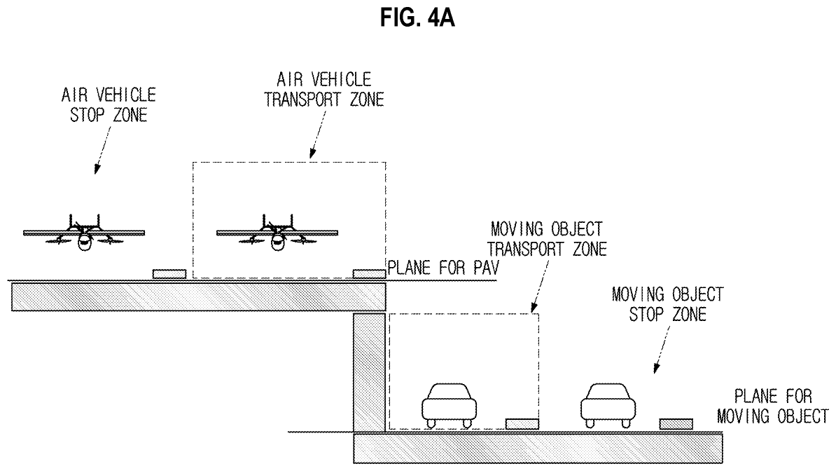

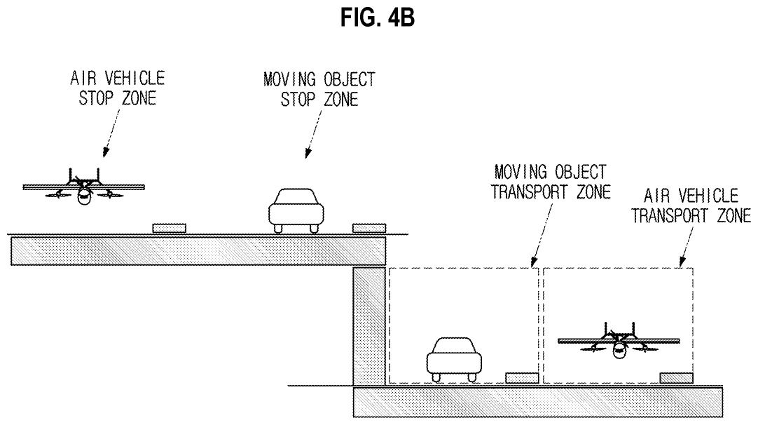

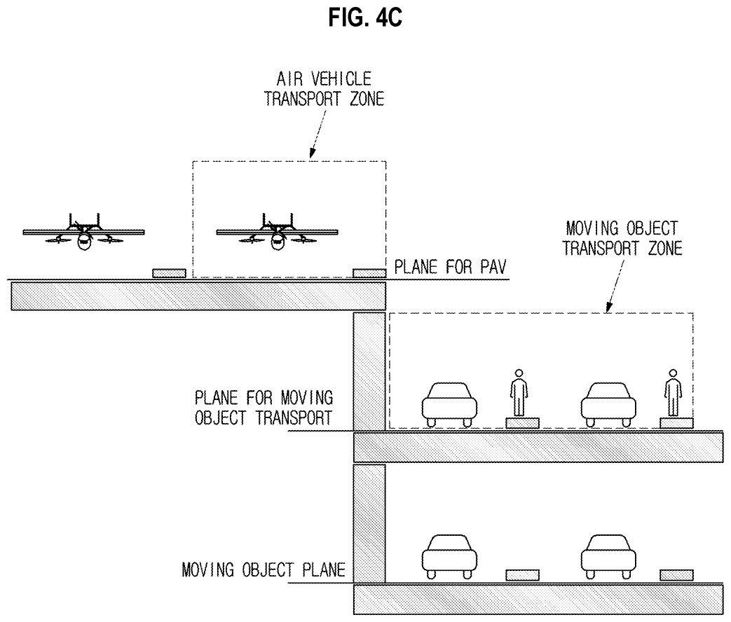

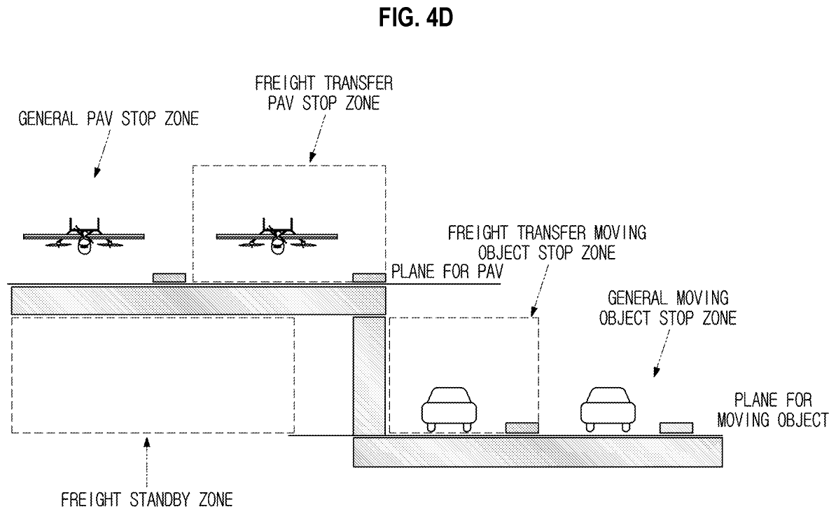

FIGS. 4A to 4D illustrate a structure of a take-off and landing facility in a multimodal transport system according to an embodiment of the present disclosure.

First, as described above, a take-off and landing facility in a multimodal transport system according to an embodiment of the present disclosure may include a stop and a take-off and landing pad, and the stop in particular may include a zone, in which an air vehicle may stop (hereinafter, referred to as ‘air vehicle stop zone’), and a zone in which a moving object may stop (hereinafter, referred to as ‘moving object stop zone’). As an example, an air vehicle stop zone and a moving object stop zone may be provided on a same plane. As another example, a take-off and landing facility may consist of a plurality of planes, and an air vehicle stop zone and a moving object stop zone may be provided on different planes. That is, a take-off and landing facility may consist of a plurality of planes, and an air vehicle stop zone and a moving object stop zone may be provided on different floors.

Furthermore, in a stop, a transport zone for transport may be prepared. As an example, a stop may include an air vehicle transport zone and a moving object transport zone. An air vehicle transport zone and a moving object transport zone may be provided on a same plane or be provided on different planes.

In order to distinguish an air vehicle transport zone and a moving object transport zone from a stop zone not used for transport (e.g. an air vehicle stop zone, a moving object stop zone), in an embodiment of the present disclosure, stop zones not used for transport will be referred to as general air vehicle stop zones and general moving object stop zones respectively.

A general air vehicle stop zone and a general moving object stop zone may be prepared in an area different from an area for an air vehicle transport zone and a moving object transport zone. As an example, a general air vehicle stop zone and an air vehicle transport zone may be prepared in a same first plane, and a general moving object stop zone and a moving object transport zone may be prepared on a second plane that is configured on a different plane from the first plane.

In addition, referring to FIG. 4D, a stop may include a zone, in which a freight transfer air vehicle may stop (hereinafter, referred to as ‘freight transfer air vehicle stop zone’), and a zone in which a freight transfer moving object may stop (hereinafter, referred to as ‘freight transfer moving object stop zone’). Also, the stop may further include a freight standby zone in which freight may be temporarily loaded and stored. As an example, a freight transfer air vehicle stop zone and a freight transfer moving object stop zone may be provided on a same plane. As another example, a take-off and landing facility may consist of a plurality of planes, and a freight transfer air vehicle stop zone, a freight transfer moving object stop zone, or a freight standby zone may be provided on different planes. That is, a take-off and landing facility may consist of a plurality of floors, and a freight transfer air vehicle stop zone, a freight transfer moving object stop zone, or a freight standby zone may be provided on different floors.

Although, in an embodiment of the present disclosure, a general air vehicle stop zone, an air vehicle transport zone, a general moving object stop zone, a moving object transport zone are exemplified with respect to their structures, but the present disclosure is not limited thereto, and the structures may be modified and applied in various ways by those skilled in the art.

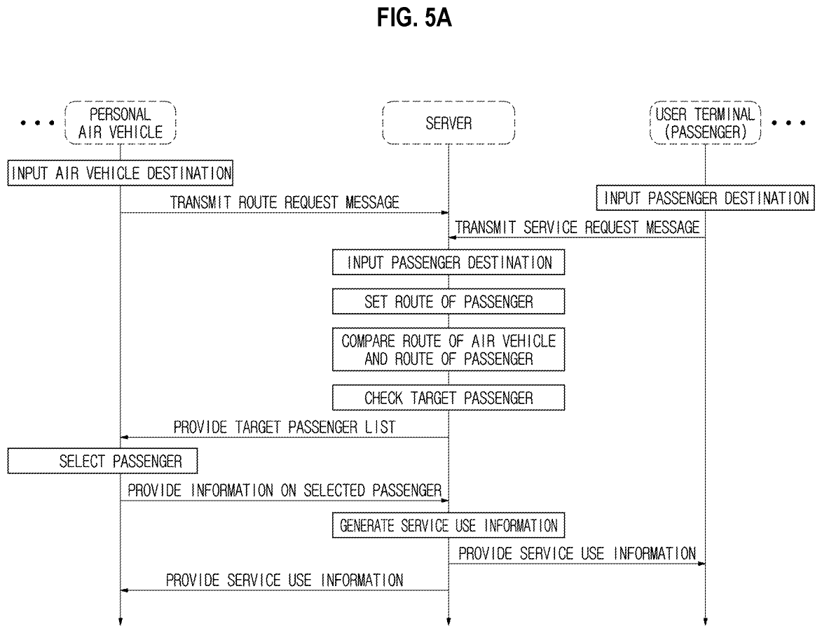

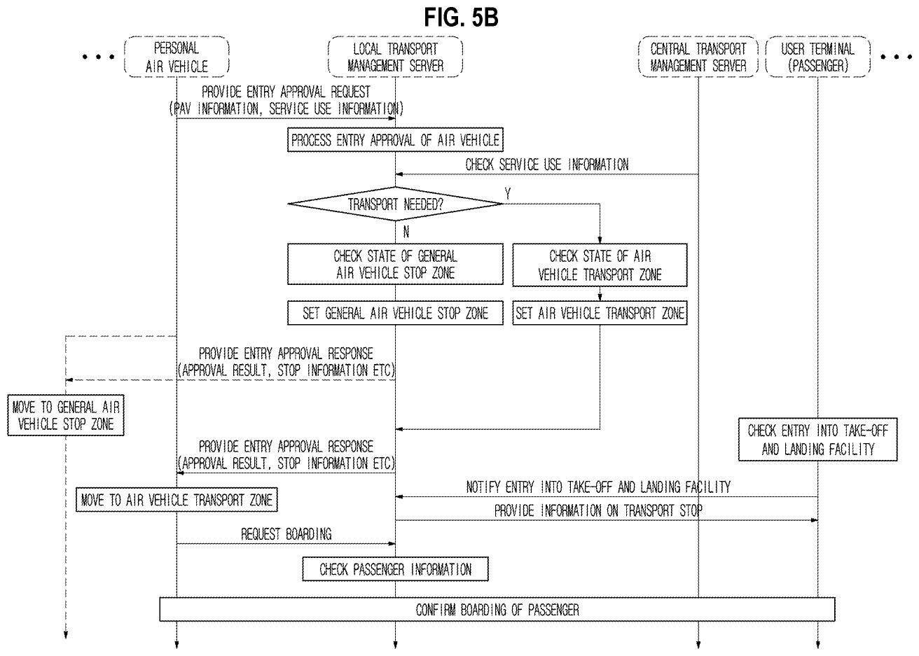

FIG. 5A is a view illustrating an operation of setting multimodal traffic service use in a multimodal transport system according to an embodiment of the present disclosure.

Referring to FIG. 5A, a central transport management server provided in a multimodal transport system may be connected with a personal air vehicle and a user terminal.

Herein, the personal air vehicle, as an air vehicle that provides a boarding space of a user in a multimodal traffic service, may be a personal air vehicle that is registered to a central transport management server beforehand in order to provide a multimodal traffic service. A user may get in a personal air vehicle, and in an embodiment of the present disclosure, a user who gets in a personal air vehicle is referred to as a driver. In an embodiment of the present disclosure, a multimodal transport system provides a multimodal traffic service using a personal air vehicle or a moving object. Hereinafter, a multimodal transport system will be exemplified to provide a multimodal traffic service using a personal air vehicle, but the present disclosure is not limited thereto, and the multimodal transport system may be applied to a moving object as an alternative to a personal air vehicle.

Meanwhile, a user terminal is a terminal device carried by a user (hereinafter, referred to as ‘passenger’) using a multimodal traffic service and may be a terminal device that is registered to a central transport management server in order to use the multimodal traffic service.

In order to provide a multimodal traffic service, a personal air vehicle may receive an input of destination information and request route information to a destination to a central transport management server. As an example, a personal air vehicle may deliver a route information request message to a central transport management server. Herein, the route information request message may include an identifier of the personal air vehicle, information on a departure point of the air vehicle, information on a destination of the air vehicle, and the like.

In addition, the personal air vehicle may check whether or not a multimodal traffic service is to be provided and may configure a route information request message including a checking result (e.g. whether or not the multimodal traffic service is to be provided). As an example, the personal air vehicle may provide an environment (menu or UI), in which whether or not a multimodal traffic service is to be provided may be input, and receive an input from a user of the personal air vehicle through such an environment. As another example, the user of the personal air vehicle may set and store beforehand whether or not a multimodal traffic service is to be provided, and the personal air vehicle may check, based on the stored information, whether or not the multimodal traffic service is to be provided. Herein, whether or not the multimodal traffic service is to be provided may be stored and managed in the personal air vehicle or the central transport management server.

As another example, whether or not the multimodal traffic service is to be provided may be stored and managed based on a predetermined condition. As an example, a user may set beforehand a condition of situation capable of providing a multimodal traffic service, and a personal air vehicle or a central transport management server may check a situation capable of providing the multimodal traffic service by checking the preset condition and, when the situation capable of providing the multimodal traffic service is met, may determine that the multimodal traffic service can be provided. As an example, the personal air vehicle or the central transport management server may determine a situation capable of providing the multimodal traffic service, based on time information, weather information, information on a user's schedule and the like.

The central transport management server may set a route to a destination by using information on a departure point of an air vehicle and information on a destination of the air vehicle. A route from a departure point to a destination may include a waypoint, and the central transport management server may generate, based on this, waypoint information indicating the waypoint and also generate and manage personal air vehicle route information including information on the departure point of the air vehicle and information on the destination of the air vehicle. Particularly, a take-off and landing facility may be included in a route from a departure point to a destination. Herein, the take-off and landing facility may include not only a take-off and landing facility, which a personal air vehicle enters, but also a take-off and landing facility that is located close to a route that the personal air vehicle passes through.

Considering what is described above, information on a take-off and landing facility may include at least one of a name of the take-off and landing facility, location information and an identifier. In addition, information on a take-off and landing facility may be information corresponding to a destination of a personal air vehicle. As another example, information on a take-off and landing facility may be information corresponding to a waypoint of an air vehicle.

Furthermore, information on a route of a personal air vehicle may further include information on times when the air vehicle passes a departure point, a destination, a waypoint and the like.

Meanwhile, a central transport management server may provide a user terminal with an environment for providing a multimodal traffic service. Based on such an environment, a user, who is a passenger, may input information for using the multimodal traffic service (e.g. User information, information on a passenger's departure point, information on a passenger destination) by using a user terminal. In addition, the information for using the multimodal traffic service may further include a service use time.

In response to this, the user terminal may generate a service request message, which includes information for using the multimodal traffic service, and provide the service request message to the central transport management server.

The central transport management server may set a route to a destination by using information on a passenger's departure point and information on the passenger destination. A route from a departure point to a destination may include a waypoint, and the central transport management server may generate, based on this, waypoint information indicating the waypoint and also generate and manage information on the passenger's route including information on the departure point of a personal air vehicle and information on the destination of the personal air vehicle. Particularly, a take-off and landing facility may be included in a route from a departure point to a destination. Herein, the take-off and landing facility may include also a take-off and landing facility that is located close to a route that the passenger passes through.

The central transport management server may compare route information of an air vehicle and route information of a passenger and check whether or not those two pieces of route information indicate a same route. When a same route is indicated, the central transport management server may determine the passenger as a service target passenger.

Furthermore, the multimodal transport system may include a plurality of personal air vehicles and a plurality of passengers. The central transport management server may detect route information indicating a same route by comparing route information of a plurality of air vehicles and route information of a plurality of passengers, and based on this, may determine a passenger with the same route as a target passenger. In addition, the central transport management server may configure a list for target passengers (hereinafter, ‘target passenger list’) and provide the target passenger list to a corresponding personal air vehicle. As an example, the target passenger list may include at least one of information on a target passenger, information on the passenger's getting-in point, a getting-in time, information on the passenger's getting-off point, and a getting-off time.

Meanwhile, the personal air vehicle may check a target passenger list and select at least one passenger. As an example, the personal air vehicle may display the target passenger list and check at least one passenger selected by a driver. As another example, the personal air vehicle may receive an input of a passenger selection condition from the driver and select at least one passenger by applying the passenger selection condition to the target passenger list.

Next, the personal air vehicle may provide information on the at least one passenger thus selected to the central transport management server. In addition, the central transport management server may configure service use information including the at least one passenger who is selected and may deliver the service use information to a user terminal. Herein, the service use information may include at least one among information on the personal air vehicle, information on a passenger's getting-in point, a getting-in time, information on a passenger's getting-off point, and a getting-off time.

The user terminal may provide the service use information to a user.

FIG. 5B is a view illustrating an operation of processing a multimodal traffic service in a multimodal transport system according to an embodiment of the present disclosure.

Referring to FIG. 5B, as a personal air vehicle approaches a take-off and landing facility, the personal air vehicle may transmit an entry approval request to a local transport management server in order to enter the take-off and landing facility. Herein, the entry approval request may include the service use information together with information on the air vehicle (identifier of the air vehicle, type of the air vehicle, user of the air vehicle and the like). The local transport management server may process approval for the entry of the air vehicle based on the information on the air vehicle. Especially, the local transport management server may transmit the service use information to a central transport management server and request confirmation of the service use information.

In case the service use information is confirmed to be valid information, the local transport management server may check whether or not an air vehicle requests transport in the take-off and landing facility. In case the air vehicle requests transport in the take-off and landing facility, the local transport management server may check a condition of an air vehicle transport zone. For example, the local transport management server may check whether or not there is an available stop area in an area that is allocated as the air vehicle transport zone, and may determine one of the available stop areas and set it as a stop of the air vehicle.

Next, the local transport management server may transmit an entry approval response to the air vehicle. Herein, the entry approval response may include a result of entry approval, information on the stop and the like. In response to this, the air vehicle may move to and stop at the air vehicle transport zone based on the information on the stop.

Next, the air vehicle may transmit a boarding request of a passenger to the local transport management server, and the local transport management server may check information on a passenger, who is to get in the air vehicle, that is, passenger information.

As an example, a passenger's user terminal may identify entry into a take-off and landing facility and notify the entry into the take-off and landing facility to the local transport management server. Herein, the user terminal may notify the entry into the take-off and landing facility to the local transport management server by using the service use information described above. In response to this, the local transport management server may check and provide information on the air vehicle and information on the stop of the air vehicle based on the service use information to the user terminal.

Meanwhile, the local transport management server may check the above-described passenger information based on the service use information that is obtained when checking the passenger's entry into the take-off and landing facility.

Next, the passenger may check the information on the air vehicle and the information on the stop of the air vehicle and proceed to get in the air vehicle. At this time, the air vehicle and the user terminal may communicate with each other and check the passenger's getting in the air vehicle.

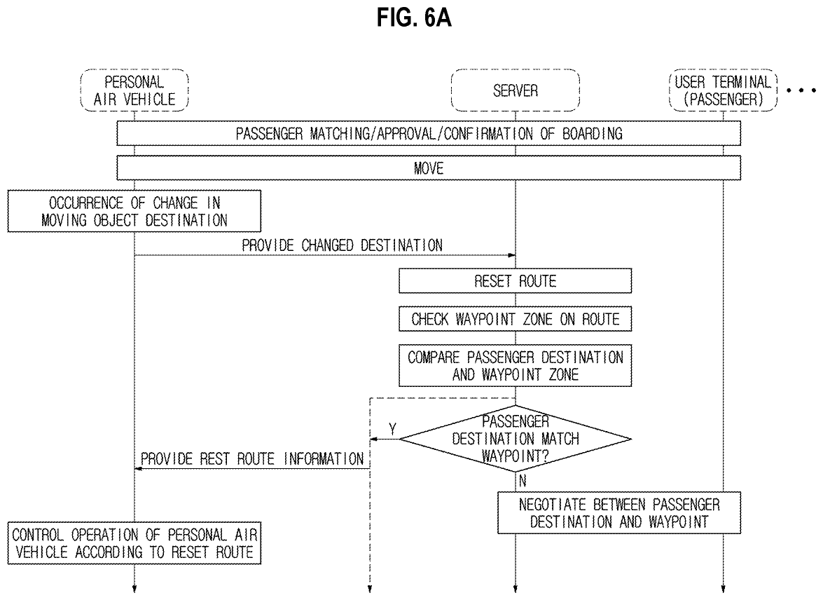

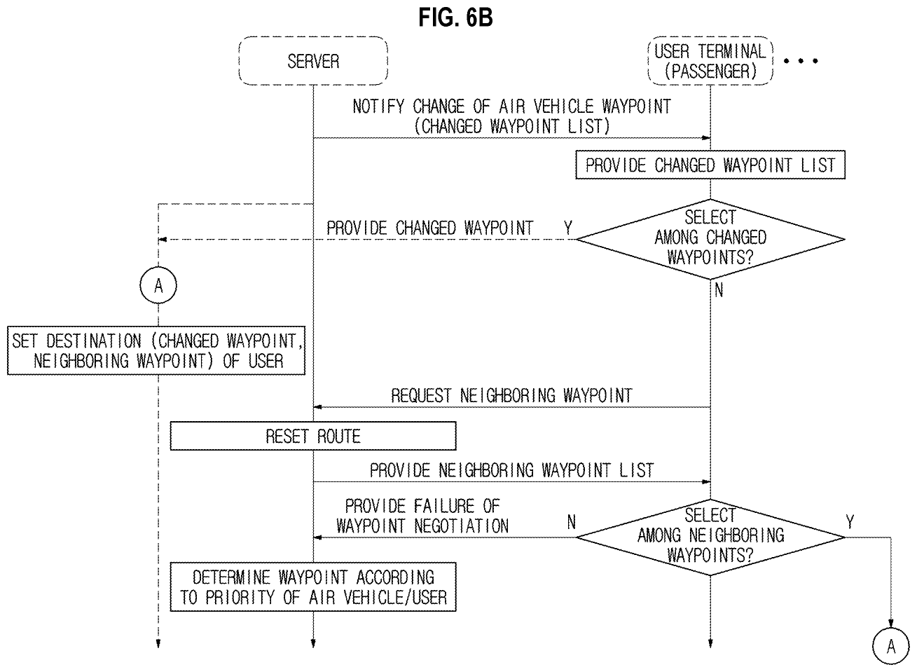

FIG. 6A is a view illustrating an operation of processing a change of destination of a personal air vehicle in a multimodal transport system according to an embodiment of the present disclosure.

When using a multimodal traffic service, a change of destination or waypoint of a personal air vehicle may occur. As an operation of a multimodal transport system may be processed in the same way whether a personal air vehicle undergoes a change of destination or a change of waypoint, an operation of processing a situation where a change of destination of a personal air vehicle occurs will be described in an embodiment of the present disclosure. In addition, in case a change of waypoint of a personal air vehicle occurs, the multimodal transport system may process the situation in the same way as a situation where a change of destination of a personal air vehicle occurs.

FIG. 6A illustrates an operation of processing a change of destination in a situation where a destination change request of a personal air vehicle occurs.

Referring to FIG. 6A, when a change of destination of a personal air vehicle occurs, the personal air vehicle may provide information on a changed destination to a central transport management server. Accordingly, the central transport management server may reset a route based on a current location of the air vehicle and the information on the changed destination.

The central transport management server may check a waypoint or a destination on the reset route and compare the checked waypoint with a passenger's waypoint or destination. Herein, the waypoint or destination on the reset route may be a take-off and landing facility.

In case the waypoint or destination on the reset route is identical with the passenger's waypoint or destination, the central transport management server may provide information on the reset route to the personal air vehicle, and the personal air vehicle may control operation according to the information on the reset route.

On the other hand, in case the destination or waypoint included in the reset route is not identical with the passenger's waypoint or destination, the central transport management server may execute a negotiating operation for the passenger's waypoint or destination.

FIG. 6B is a view illustrating an operation of negotiation for the changed destination of FIG. 6A.

Referring to FIG. 6B, the central transport management server may notify a user terminal of the occurrence of a change of destination of the personal air vehicle. Herein, information notified to the user terminal may include a list of waypoints or destinations included on the reset route.

The user terminal may provide the received list of destinations or waypoints to the user and also provide an environment in which at least one destination or waypoint may be selected by the user. When the user selects a destination or a waypoint present in the list, the user terminal may provide information on a changed destination or waypoint to the central transport management server.

On the other hand, the user may not want any destination or waypoint included in the list. Considering this, the user terminal may provide an environment capable of requesting a neighboring waypoint. As an example, the user terminal may further provide a neighboring waypoint request menu or UI. The user may select the neighboring waypoint request menu or UI through the user terminal, and the user terminal, in response to this, may transmit a message requesting the provision of a neighboring waypoint to the central transport management server.

The central transport management server may identify at least one neighboring waypoint near the received destination or waypoint and configure and provide a neighboring waypoint list including at least one neighboring waypoint to the user terminal.

Next, the user terminal may provide the neighboring waypoint list to the user and also provide an environment in which at least one neighboring waypoint may be selected by the user. When the user selects a neighboring waypoint present in the list, the user terminal may provide information on the selected waypoint to the central transport management server. When the user does not select any neighboring waypoint present in the list, the user terminal may notify failure of waypoint negotiation to the central transport management server.

In addition, as the waypoint negotiation fails, the central transport management server may check a priority of the air vehicle or the passenger and set a waypoint according to the checked priority. The priority of an air vehicle or a passenger may be set based on driver information or passenger information. As an example, the central transport management server may store and manage a service mileage for a driver or a passenger and determine a priority of a waypoint based on such a service mileage. For example, a driver's mileage and a passenger's mileage may be compared, and a higher priority may be given to a user (e.g. driver or passenger) with a relatively higher mileage. As another example, the central transport management server may store and manage a penalty score as a service mileage for a driver or a passenger and determine a priority of a waypoint based on such a penalty score. For example, a driver's penalty score and a passenger's penalty score may be compared, and a higher priority may be given to a user (e.g. driver or passenger) with a relatively lower penalty score.

Furthermore, the central transport management server may manage the above-described service mileage or penalty score by considering a cumulative number of destination (or waypoint) changes, a frequency of destination (or waypoint) change within a predetermined period, the number of uses of the multimodal traffic service, an amount of money spent on the multimodal traffic service, and the like.

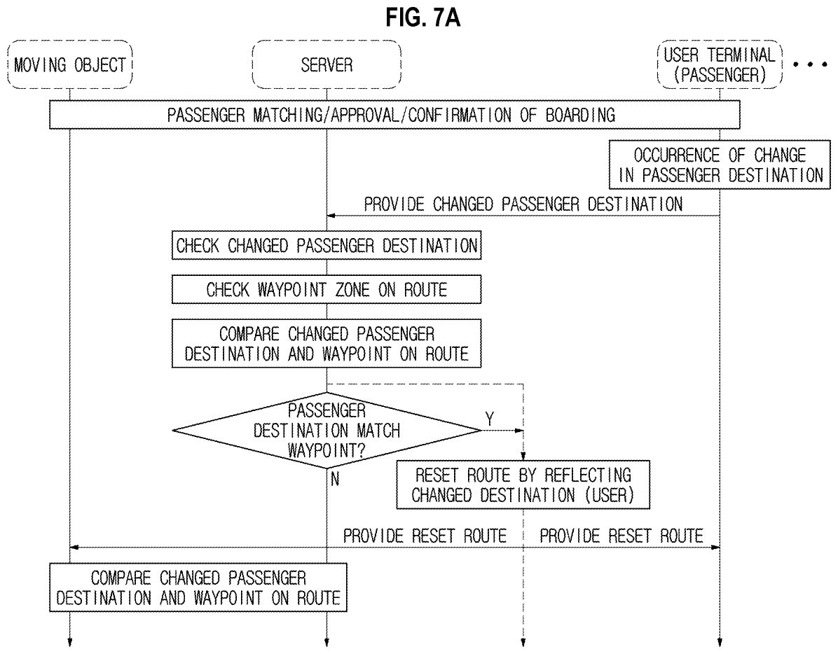

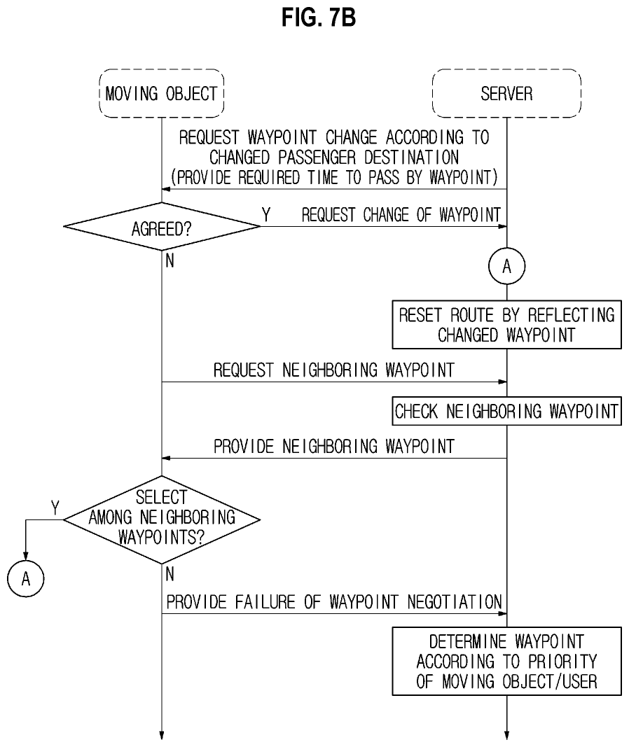

FIG. 7A is another view illustrating an operation of processing a change of destination of a personal air vehicle in a multimodal transport system according to an embodiment of the present disclosure.

When using a multimodal traffic service in a multimodal transport system, a change of destination of a passenger may occur. FIG. 7A illustrates an operation of processing a change of destination in a situation where a destination change request of a passenger occurs.

Referring to FIG. 7A, when a change of destination of a passenger occurs, the passenger may input information on a changed destination by using a user terminal and provide the input information on the changed destination to a central transport management server. Accordingly, the central transport management server may check waypoint information, destination information and the like, which are included on a route of an air vehicle, and compare the checked information with the information on the changed destination.

In case the checked information is identical with the information on the changed destination, the route of the air vehicle needs not be changed. However, in case the checked information is not identical with the information on the changed destination, the route of the air vehicle needs to be changed.

Furthermore, a waypoint or a destination included in the route of the air vehicle may be a take-off and landing facility. A waypoint included in the route of the air vehicle may include a take-off and landing facility, which the air vehicle enters, and a take-off and landing facility that the air vehicle does not enter but goes past. Considering this, the central transport management server may set and distinguish waypoints included in the route of the air vehicle between a take-off and landing facility that the air vehicle enters and a take-off and landing facility that the air vehicle does not enter but goes past.

Considering what is described above, even when the checked information is identical with the information on the changed destination, the central transport management server may check whether a waypoint included by a route of the air vehicle is a take-off and landing facility that the air vehicle enters or a take-off and landing facility that the air vehicle does enter but goes past. In addition, the central transport management server may reset a route of the air vehicle by reflecting a type of a take-off and landing facility according to the changed passenger destination and provide the reset route to the user terminal and the personal air vehicle.

On the other hand, in case the changed passenger destination is not identical with the waypoint or destination on the preset route, the central transport management server may perform a negotiating operation for the changed passenger destination and the waypoint or destination of the air vehicle.

FIG. 7B is a view illustrating an operation of negotiation for the changed destination of FIG. 7A.

Referring to FIG. 7B, the central transport management server may notify the personal air vehicle of the occurrence of a change of passenger destination. Herein, the information notified to the air vehicle may include information indicating the changed passenger destination. Furthermore, the information notified to the air vehicle may further include information on a time for arriving at the destination of the personal air vehicle when a route is configured again by reflecting the changed passenger destination.

The personal air vehicle may provide the changed passenger destination to a user and also provide an environment in which an input may be received regarding whether or not to approve the changed passenger destination. In case the driver approves the changed passenger destination, the personal air vehicle may provide the changed passenger destination to the central transport management server.

On the other hand, the changed passenger destination may not be a point desired by the driver. Considering this, the personal air vehicle may provide an environment in which a neighboring waypoint may be requested. As an example, the personal air vehicle may further provide a neighboring waypoint request menu or UI. The driver may select the neighboring waypoint request menu or UI through the personal air vehicle, and the personal air vehicle, in response to this, may transmit a message requesting the provision of a neighboring waypoint to the central transport management server.

The central transport management server may identify at least one neighboring waypoint near the changed passenger destination and configure and provide a neighboring waypoint list including at least one neighboring waypoint to the personal air vehicle.

Next, the personal air vehicle may provide the neighboring waypoint list to the driver and also provide an environment in which at least one neighboring waypoint may be selected by the driver. When the driver selects a neighboring waypoint present in the list, the air vehicle may provide information on the selected waypoint to the central transport management server. When the driver does not select any neighboring waypoint present in the list, the air vehicle may notify failure of waypoint negotiation to the central transport management server.

In addition, as the waypoint negotiation fails, the central transport management server may check a priority of the air vehicle or the passenger and set a waypoint according to the checked priority. The priority of an air vehicle or a passenger may be set based on driver information or passenger information. As an example, the central transport management server may store and manage a service mileage for a driver or a passenger and determine a priority of a waypoint based on such a service mileage. For example, a driver's mileage and a passenger's mileage may be compared, and a higher priority may be given to a user (e.g. driver or passenger) with a relatively higher mileage. As another example, the central transport management server may store and manage a penalty score as a service mileage for a driver or a passenger and determine a priority of a waypoint based on such a penalty score. For example, a driver's penalty score and a passenger's penalty score may be compared, and a higher priority may be given to a user (e.g. driver or passenger) with a relatively lower penalty score.

In addition, the multimodal transport system may be configured to enable a user to transfer a thing. As an example, the multimodal transport system may include a freight handling server that registers and manages information (freight information) that is necessary to transport freight from a departure point to a destination. The multimodal transport system may provide freight information a personal air vehicle or a moving object and an environment in which predetermined freight to be transferred through a personal air vehicle or a moving object may be selected. The multimodal transport system may provide an environment in which it is possible to check or select information for freight transportation such as an identifier of freight, an identifier of an entity (personal air vehicle, moving object, etc.), which will transfer, a type of an entity (personal air vehicle, moving object, etc.), which will transfer, information on a transfer departure point, information on a transfer destination, a transfer departure time, a transfer arrival time and the like. Also, the multimodal transport system may include an environment, in which the freight may be loaded or unloaded, and an apparatus capable of transferring freight such as a conveyor belt, a freight transfer robot and the like.

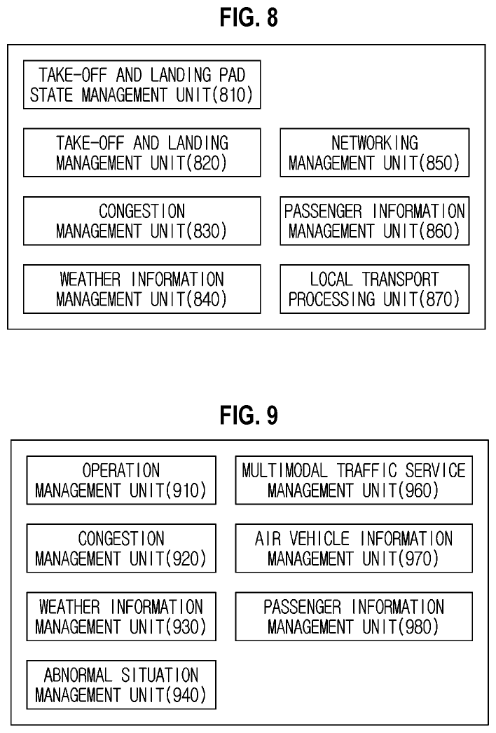

FIG. 8 is a block diagram illustrating a configuration of a local transport management server provided in a personal air vehicle control system according to an embodiment of the present disclosure.

Referring to FIG. 8, the local transport management server may include a take-off and landing pad state management unit 810, a take-off and landing management unit 820, a congestion management unit 830, a weather information management unit 840, a networking management unit 850, a passenger information management unit 860, and a local transport processing unit 870.

As exemplified in FIGS. 3A to 4A and FIG. 4C, a take-off and landing facility may include a take-off and landing pad and a stop. Herein, the stop may include an air vehicle stop zone and a moving object stop zone. Also, the stop may include a transport zone, that is, an air vehicle transport zone and a moving object transport zone. Based on the structure of such a take-off and landing facility, the take-off and landing pad state management unit 810 may monitor and manage an occupancy state of each zone included in a take-off and landing pad and a stop. To this end, the take-off and landing facility may be equipped with an apparatus capable of detecting an occupancy state of each zone, and such an apparatus may be connected with the take-off and landing pad state management unit 810. As an example, the apparatus may include a sensor capable of checking whether or not an air vehicle or a moving object enters. As another example, the apparatus may include a camera device and an identification module that is capable of detecting an identifier of an air vehicle or a moving object, which enters the zone, by analyzing an image received from the camera device.

As an example, the take-off and landing pad state management unit 810 may manage identification numbers of stops and take-off and landing pads, which are included in the take-off and landing facility, and also manage information on a moving object or an air vehicle, which stops at a stop or a take-off and landing pad.

Furthermore, the occupancy state of each zone, that is, information checked by the take-off and landing pad state management unit 810 may be provided to the take-off and landing management unit 820, the congestion management unit 830 and the local transport processing unit 870. The take-off and landing management unit 820 may execute such operations as management of take-off and landing approval for an air vehicle, management of information on a personal air vehicle for which landing is approved, and management of information on a personal air vehicle that enters a landing pad. Also, the take-off and landing management unit 820 may receive, from the central transport management server, and confirm information on a waypoint of a personal air vehicle in operation, information on a destination, and expected arrival time at a take-off and landing facility. In addition, the take-off and landing management unit 820 may store and manage information on a personal aerial vehicle, for which a take-off or landing approval is requested, and driver information. For example, the take-off and landing management unit 820 may store temporarily information on a personal air vehicle, for which a take-off approval is requested, and driver information and, when the personal air vehicle enters an air vehicle operation zone, may deliver the information on the personal air vehicle and the driver information to the central transport management server and then delete the temporarily stored information. In addition, the take-off and landing management unit 820 may store information on a personal aerial vehicle, for which a landing approval is requested, and driver information and, when the personal aerial vehicle enters a take-off and landing field or a stop, may store and manage the information on the personal aerial vehicle and the driver information. Furthermore, when the personal air vehicle, which was present in the take-off and landing field or the stop, goes out of the take-off and landing field or the stop through a road zone, the take-off and landing management unit 820 may delete the information on the personal air vehicle and the driver information.

The congestion management unit 830 may check and manage a degree of congestion for a corresponding take-off and landing facility based on occupancy information of the take-off and landing facility and reservation information of a personal aerial vehicle. Specifically, the congestion management unit 830 may receive an occupancy state of a take-off and landing facility, that is, a take-off and landing pad and a stop from the take-off and landing pad state management unit 820 and check a degree of congestion by using the occupancy state of the take-off and landing pad and the stop.

Furthermore, the congestion management unit 830 may receive, from the take-off and landing management unit 820, information on a waypoint of a personal air vehicle in operation, information on a destination, and expected arrival time at a take-off and landing facility. Also, the congestion management unit 830 may predict and manage a degree of congestion for the take-off and landing facility by reflecting waypoint information, destination information and expected arrival time. As an example, the congestion management unit 830 may calculate a degree of congestion for a take-off and landing facility every predetermined time (e.g. 10 minutes, 30 minutes, 1 hour) by reflecting expected arrival time of a personal air vehicle based on a current occupancy state of the take-off and landing facility.

The weather information management unit 840 may receive and store central weather information provided by the central transport management server. In addition, a take-off and landing facility may be equipped with at least one weather observation device, and local weather information, which is identified through the weather observation device, may be provided to the weather information management unit 840. Based on this, the weather information management unit 840 may store and manage local weather information and provide the local weather information to the central control server.

The networking management unit 850 may manage the connection and maintenance with the central transport management server and the connection and maintenance with a neighboring local transport management server. In addition, the networking management unit 850 may manage connection with a moving object or a personal air vehicle.

The passenger information management unit 860 may detect a passenger's entry into a take-off and landing facility. In addition, the passenger information management unit 860 may detect, track and manage the location of a passenger in the take-off and landing facility. As an example, the passenger information management unit 860 may perform communication with a user terminal via a communication module and check whether or not the passenger enters the take-off and landing facility or the passenger's location in the take-off and landing facility.

The local transport processing unit 870 may check, based on service use information, whether or not a personal air vehicle uses a multimodal traffic service and may set a zone, in which the personal air vehicle will stop, and a stop. As an example, in case the personal air vehicle is set to use the multimodal traffic service, the zone, in which the personal air vehicle will stop, may be set as an air vehicle transport zone, and the stop may be set within the air vehicle transport zone. Also, the local transport processing unit 870 may provide the set stop zone and information on the stop to the personal air vehicle. Herein, whether or not to use the multimodal traffic service may be received from the central transport management server.

Also, the local transport processing unit 870 may receive information on a user (passenger), who requests to get in the air vehicle, from the central transport management server and provide the stop zone and the information on the stop to the user (passenger) who requests to get in the air vehicle.

FIG. 9 is a block diagram illustrating a configuration of a central transport management server provided in a personal air vehicle control system according to an embodiment of the present disclosure.

Referring to FIG. 9, a central transport management server may include an operation management unit 910, a congestion management unit 920, a weather information management unit 930, an abnormal situation management unit 940, a networking management unit 950, a multimodal traffic service management unit 960, and an air vehicle information management unit 970, and a passenger information management unit 980.

The operation management unit 910 may manage information related to an operation of a personal air vehicle that enters an air vehicle operation zone. For example, the operation management unit 910 may store and manage the departure point information, destination information and real-time location information of the personal air vehicle.

The operation management unit 910 may check and store charging information for a personal air vehicle that enters and exits an air vehicle operation zone.

The congestion management unit 920 may check and manage congestion information of each section in an aerial vehicle operation zone based on the departure point information, destination information and real-time location information of a personal aerial vehicle.

The weather information management unit 930 may check and store central weather information. In addition, the weather information management unit 930 may store central weather information in the local control server. The weather information management unit 930 may receive and store local weather information from the local control server.

The abnormal situation management unit 940 may monitor whether or not an abnormal situation occurs in a specific location or section, based on congestion information of each section in an air vehicle operation zone and central weather information. When an abnormal situation occurs, the abnormal situation management unit 940 may transmit an event of occurrence of the abnormal situation to a personal air vehicle or the local control server.

The networking management unit 950 may manage the connection and maintenance with a local control server and the connection and maintenance with a neighboring local control server. In addition, the networking management unit 950 may manage connection with a moving object or a personal air vehicle and especially manage connection and maintenance with a personal air vehicle in an air vehicle operation zone through a control channel.

Particularly, the multimodal traffic service management unit 960 may configure an environment for providing a multimodal traffic service between a personal air vehicle and a passenger. As an example, in order to provide the multimodal traffic service, the multimodal traffic service management unit 960 may receive a route information request message from a personal air vehicle and set route information for moving the personal air vehicle. Also, the multimodal traffic service management unit 960 may check passengers' destinations through the passengers' user terminals and determine a passenger who matches the route information for moving the personal air vehicle, thereby providing a multimodal traffic service.

Also, the multimodal traffic service management unit 960 may receive an input of a destination change from a personal air vehicle or a user terminal and reset a route of the personal air vehicle according to the changed destination. When resetting the route of the personal air vehicle, the multimodal traffic service management unit 960 may process a waypoint negotiation based on passenger information or personal air vehicle information (or driver information).

The air vehicle information management unit 970 may store and manage information on a personal air vehicle, and the passenger information management unit 980 may store and manage a user (passenger) who uses a multimodal traffic service. Particularly, the multimodal traffic service management unit 960 may produce and manage mileage information for service use, while processing a multimodal traffic service, and the air vehicle information management unit 970 and the passenger information management unit 980 may store and manage mileage information for service use.

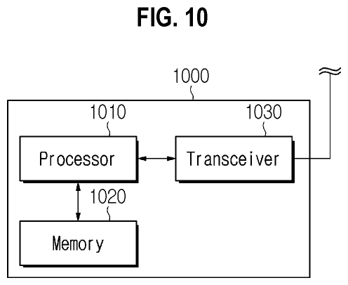

FIG. 10 is a view illustrating an apparatus configuration according to an embodiment of the present disclosure.

Referring to FIG. 10, the apparatus may include at least one of the above-described moving object, a device, a server and an RSU. In other words, the apparatus may be configured to communicate and work with another device. The present disclosure is not limited to the above-described embodiment. For example, for the above-described operation, an apparatus 1000 may include one or more among a processor 1010, a memory 1020, and a transceiver 1030. In other words, the apparatus may include a necessary configuration for communicating with another apparatus. In addition, the apparatus may include another configuration apart from the above-described configuration. In other words, the apparatus may have a configuration, which includes the above-described apparatus for communicating with another device but is not limited thereto, and may be operated based on what is described above.

Although the exemplary methods of the present disclosure described above are represented by a series of acts for clarity of explanation, they are not intended to limit the order in which the steps are performed, and if necessary, each step may be performed simultaneously or in a different order. In order to implement a method according to the present disclosure, the illustrative steps may include an additional step or exclude some steps while including the remaining steps. Alternatively, some steps may be excluded while additional steps are included.

The various exemplary embodiments of the disclosure are not intended to be all-inclusive and are intended to illustrate representative aspects of the disclosure, and the features described in the various exemplary embodiments may be applied independently or in a combination of two or more. In addition, the various exemplary embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays. A general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various exemplary embodiments to be performed on a device or computer, and a non-transitory computer-readable medium in which such software or instructions are stored and are executable on a device or computer.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. A method for providing a multimodal transport service in a multimodal transport system comprising at least one of at least one traffic object, a server apparatus, and a user terminal, the method comprising:
checking route information for the at least one traffic object;
checking destination information of at least one passenger;
setting service use information based on the route information for the at least one traffic object and the destination information of the at least one passenger;
checking the service use information of the traffic object that approaches a take-off and landing facility; and
processing, based on the service use information, the at least one passenger's getting-in to the at least one traffic object.

2. The method of claim 1, wherein the setting of the service use information comprises identifying the at least one passenger corresponding to waypoint information or destination information for the at least one traffic object.

3. The method of claim 1, wherein the setting of the service use information comprises:
providing a target passenger list, which includes the at least one passenger, to the at least one traffic object; and
selecting the at least one passenger included in the target passenger list.

4. The method of claim 1, wherein the service use information comprises at least one of traffic object information, information on a passenger's getting-in location, a getting-in time, information on a passenger's getting-off location, and a getting-off time.

5. The method of claim 4, wherein the traffic object comprises at least one of an air vehicle and a moving object.

6. The method of claim 1, further comprising determining a change in the destination or waypoint of the at least one traffic object.

7. The method of claim 6, further comprising resetting a route by reflecting the changed destination or waypoint of the at least one traffic object.

8. The method of claim 7, further comprising determining whether or not a destination or a waypoint, which is included in the reset route, matches the destination of the at least one passenger.

9. The method of claim 8, further comprising controlling an operation of the at least one traffic object according to the reset route, as the destination or waypoint, which is included in the reset route, matches the destination of the at least one passenger.

10. The method of claim 9, further comprising processing a waypoint negotiation between the destination of the at least one passenger and the at least one traffic object, as the destination or waypoint, which is included in the reset route, does not match the destination of the at least one passenger.

11. The method of claim 10, wherein the processing of the waypoint negotiation between the destination of the at least one passenger and the at least one traffic object comprises:
providing a waypoint list, which is included in the reset route, to a user terminal of the passenger; and
resetting the destination of the at least one passenger by selecting at least one waypoint included in the list.

12. The method of claim 10, wherein the processing of the waypoint negotiation between the destination of the at least one passenger and the at least one traffic object comprises:
checking at least one neighboring waypoint; and
resetting the destination of the at least one passenger by using the at least one neighboring waypoint.

13. The method of claim 10, wherein the processing of the waypoint negotiation between the destination of the at least one passenger and the at least one traffic object comprises:
determining a priority for the at least one traffic object or the at least one passenger; and
determining the waypoint of the at least one traffic object by reflecting the priority.

14. The method of claim 13, further comprising managing a mileage for the at least one traffic object and a mileage for the at least one passenger.

15. The method of claim 14, wherein the determining of the priority comprises:
checking the mileage for the at least one traffic object and the mileage for the at least passenger; and
determining a higher priority for either of the traffic object and the passenger, of which the mileage is relatively higher.

16. The method of claim 1, further comprising checking a change of destination for the at least one passenger.

17. The method of claim 16, further comprising:
checking whether or not the changed destination of the at least one passenger matches a waypoint or destination for the at least one traffic object;
resetting the route information, when the changed destination of the at least one passenger matches a waypoint or destination for the at least one traffic object; and
processing a waypoint negotiation between the changed destination of the at least one passenger and the at least one traffic object, when the changed destination of the at least one passenger does not match the waypoint or destination for the at least one traffic object.

18. A transport management server apparatus for processing a multimodal transport service in a multimodal transport system, the server apparatus comprising:
a communication unit configured to communicate with at least one air vehicle and at least one moving object;
at least one storage medium; and
at least one processor;
wherein the at least one processor is configured to:
set service use information based on route information for the air vehicle or the moving object and destination information of at least one passenger; and
process the at least one passenger's getting-in to the air vehicle or the moving object.

19. An at least one traffic object capable of processing a multimodal transport service in a multimodal transport system, the traffic object comprising:
a communication unit;
at least one storage medium; and
at least one processor;
wherein the at least one processor is configured to:
check route information of the at least one traffic object;
provide the route information to the transport management server;
receive a target passenger list including the at least one passenger from the transport management server;
select and provide the at least one passenger included in the target passenger list to the transport management server;
check service use information; and
provide the service use information.

20. A facility apparatus for supporting take-off and landing of at least one moving object and at least one air vehicle, the apparatus comprising:
a moving object stop where the at least one moving object stops;
an air vehicle stop where the at least one air vehicle stops;
an air vehicle transport zone where the at least one air vehicle can stop;
a moving object transport zone where the at least moving object can stop;
a take-off and landing pad where the at least air vehicle takes off and lands; and
a server apparatus configured to control an operation of the at least one moving object or the at least one air vehicle.
